(19) United States
(12) Patent Application Publication
(10) Pub. No.: US 2008/0289305 A1
(43) Pub. Date: Nov. 27, 2008

(54) Filtering System for the Air Directed Towards an Internal Combustion Engine Intake

(75) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI FILTERS S.P.A., Porto Mantovano (IT)

(21) Appl. No.: 12/094,906

(22) PCT Filed: Oct. 10, 2006
(86) PCT No.: PCT/EP06/09772

§ 371 Date: Aug. 7, 2008

(30) Foreign Application Priority Data
Nov. 29, 2005 (IT) RE2005A000134

(51) Int. Cl. B01D 24/24; B01D 46/52

(52) U.S. Cl. 55/385.3

(57) ABSTRACT

A filtering system for the air directed towards an internal combustion engine intake, comprising a feed conduit (2) conveying the air through two separate series-disposed filtering baffles (3, 4), of which a first filtering baffle (3) retains the large-dimension solid particles carried in suspension by said air, and a second filtering baffle (4) retains the smaller-dimension solid particles which have been allowed to pass by the first filtering baffle (3); said first filtering baffle (3) being of generally elongated shape and being inserted directly into said air feed conduit (2).

### TECHNICAL FIELD

The present invention relates to a filtering system for the air directed towards an internal combustion engine intake. More particularly, the present invention relates to a filtering system associated with an automotive internal combustion engine, to be located within the engine compartment of the vehicle on which the engine is installed.

### PRIOR ART

To operate diesel or petrol internal combustion engines, their cylinders must be fed with a certain air quantity withdrawn from the surrounding environment, to provide the necessary oxygen for fuel combustion.

This air is generally withdrawn through one or more air intake ports opening in the vehicle body, and is then conveyed towards an intake manifold which communicates directly with the engine cylinders via the intake valves.

The air withdrawn from the environment is known to contain solid particles in suspension having sufficiently large dimensions to seriously damage the engine if these reach the cylinder interiors.

To prevent this happening, an air filtering system is located between the air intake ports and the intake manifold, to retain said solid particles.

Said filtering system usually comprises a feed conduit connecting the air intake ports to the intake manifold, along which a generally large-dimension filter box is located containing a filtering baffle of porous material which retains the solid particles and allows the aeriform phase to pass.

During use, this filtering baffle clogs more or less rapidly, and hence requires regular maintenance with periodic replacement.

For these reasons, the filtering baffle and relative filter box have to be located in an easily accessible position of the engine compartment, thus placing a substantial limit on the distribution of the spaces available within the engine compartment itself.

To overcome this drawback, filtering systems have been proposed in which the filtering action is performed by two separate filtering baffles series-disposed along the feed conduit, each within a respective containing box.

That filtering baffle firstly traversed by the air withdrawn from the environment is provided to remove the relatively large-dimension solid particles, while the second is provided to remove the smaller particles.

In this manner, said second filtering baffle clogs very slowly and can therefore operative effectively for the entire useful life of the engine, only the first filtering baffle needing to be periodically replaced.

The presence of two separate filtering baffles gives greater freedom of space distribution within the engine compartment, because each of them has a smaller overall size than a single filtering baffle, and the second filtering baffle, which does not require maintenance, can be located in a difficultly accessible position.

A drawback of these filtering systems provided with a double filtering baffle is that the first filtering baffle, together with its containing box, is still of large size and must be located in an easily accessible position of the engine compartment, to be periodically replaced.

This size, although less than a single filtering baffle, likewise places a limitation on space distribution within the engine compartment, which is more substantial the smaller the overall available volume.

### DISCLOSURE OF THE INVENTION

The object of the present invention is to overcome the said drawback within the framework of a simple, rational and low-cost solution.

This object is attained by a filtering system for the air directed towards an internal combustion engine intake, comprising a feed conduit of generally constant cross-section conveying the air through two separate series-disposed filtering baffles of porous material, of which a first filtering baffle retains the large-dimension solid particles carried in suspension by said air, and a second filtering baffle retains the solid particles which have been allowed to pass by the first filtering baffle.

Preferably, the first filtering baffle has an average pore size between 20 and 100 micron, whereas the second filtering baffle has an average pore size less than 20 micron.

According to the invention, said first filtering baffle has a generally elongated shape and is inserted directly into the interior of the feed conduit.

By virtue of this solution, the overall size of the filtering system is reduced substantially, to become that of the second filtering baffle, which can be constructed to operate effectively for the entire useful life of the relative engine, and can hence be located in any position within the engine compartment.

To ensure that the first filtering baffle for retaining the coarse particles has a filtering capacity and life compatible with the requirements of good system operation, it must have correspondingly large dimensions, and must hence occupy a relatively lengthy portion of the feed conduit.

For this reason, in a preferred embodiment of the invention said first filtering baffle is flexible, enabling it to be adapted to any sinuous development of the air feed conduit.

### BRIEF DESCRIPTION OF THE DRAWINGS

Further characteristics and advantages of the invention will be apparent on reading the ensuing description provided by way of non-limiting example, with the aid of the figures of the accompanying drawings, in which:

FIG. 1 shows schematically an air filtering system according to the invention;

FIG. 2 shows a preferred embodiment of a filtering baffle 3 of the invention;

FIG. 3 shows an enlarged detail of the filtering baffle of FIG. 2;

FIG. 4 is a section on the line IV-IV of FIG. 3;

FIG. 5 shows the plan development of the detail of FIG. 3;

FIG. 6 shows an alternative embodiment of a filtering baffle 3 according to the invention.

### BEST MODE FOR CARRYING OUT THE INVENTION

The filtering system 1 of the present invention is provided for filtering the air directed towards the intake of an automotive internal combustion engine.

Said filtering system 1 is located in the interior of the engine compartment of the vehicle with which the engine is associated, to treat the air withdrawn from the external environment.

This air enters through one or more air intake ports which open within the vehicle body, then flows through the filtering system 1, to finally pass into an intake manifold, which is connected to the engine cylinders via the intake valves.

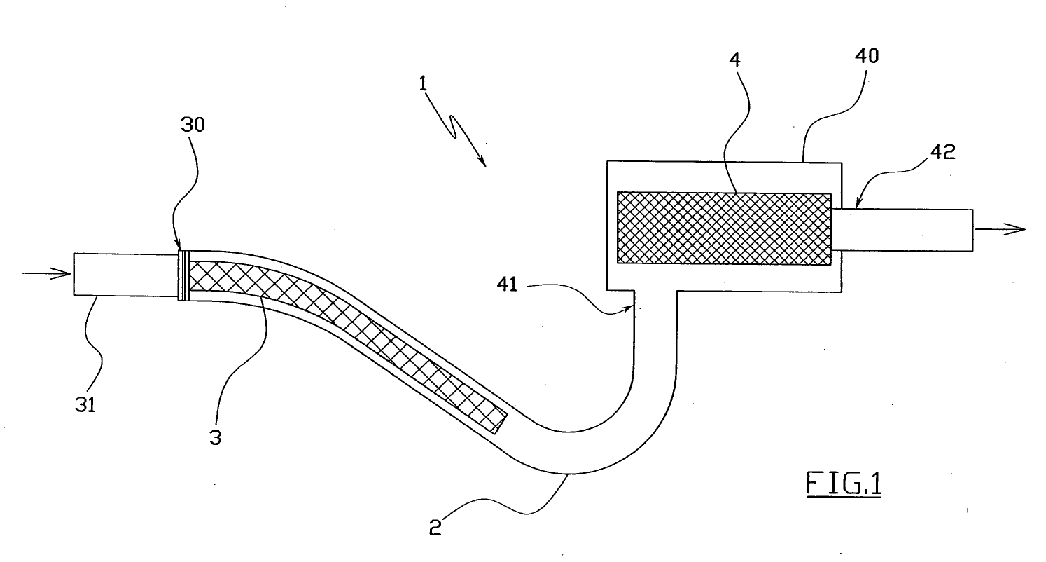

As shown in FIG. 1, the filtering system 1 comprises a feed conduit 2 of constant cross-section with a diameter generally between 70 and 90 millimetres, which conveys the air through two separate series-disposed filtering baffles, namely a first baffle 3 and a second baffle 4.

Said first and second filtering baffle 3 and 4 are provided to retain the solid particles carried in suspension by the transiting air, to prevent them reaching the engine, and possibly damaging it.

The first filtering baffle 3 presents a coarse porosity, of average pore size between 20 and 100 microns, to retain those solid particles of relatively large dimensions.

Whereas the second filtering baffle 4 presents a fine porosity, of average pore size preferably less than 20 microns, to retain the smaller particles which have been allowed to pass by the first filtering baffle 3.

By virtue of this arrangement, the second filtering baffle 4 is traversed by the air already treated by the first filtering baffle 3, and is hence subjected to very slow clogging, making it effective for the entire useful life of the engine, without the need for maintenance or replacement.

In particular, said second filtering baffle 4 can be a thin sheet of porous material, for example paper, possibly folded in accordance with a characteristic star geometry. Alternatively, it can be a deep baffle, i.e. a thick-walled tubular body, produced as an envelope of very fine fibres of synthetic material.

In this second case, the second filtering baffle 4 preferably comprises at least one layer of nanofibres, which allow high filtering efficiency with low pressure drops.

As shown in FIG. 1, the second filtering baffle 4 is contained in the interior of a relatively large-dimensioned filter box 40 presenting an inlet port 41 for the air to be filtered and an outlet port for the filtered air.

The first filtering baffle 3 is of generally elongated shape and is inserted directly into the feed conduit 2.

In this manner it does not substantially occupy a space exceeding that already occupied by said feed conduit 2, so significantly limiting the overall size of the filtering system 1.

As the first filtering baffle 3 clogs much more rapidly than the second filtering baffle 4, the invention provides for this latter to be inserted into the feed conduit 2 in a removable manner, so that it can be periodically replaced.

In the illustrated embodiment it is provided with a connection piece 30 which engages the interior of the feed conduit 2 by way of interposed sealing means.

Said connection piece 30 presents a projecting portion 31 acting as an element allowing quick connection to the vehicle air intake ports, and when released acts as a gripping element for manually inserting or withdrawing the first filtering baffle 3 into or from the feed conduit 2.

As shown in FIG. 1, the first filtering baffle 3 must be sufficiently large to have a filtering capacity and a life compatible with the requirements for good operation of the filtering system 1, and must hence occupy a relatively long portion of the feed conduit 2.

For this reason, according to the invention it is flexible to be able to adapt to any sinuous development of the feed conduit 2 into which it is inserted.

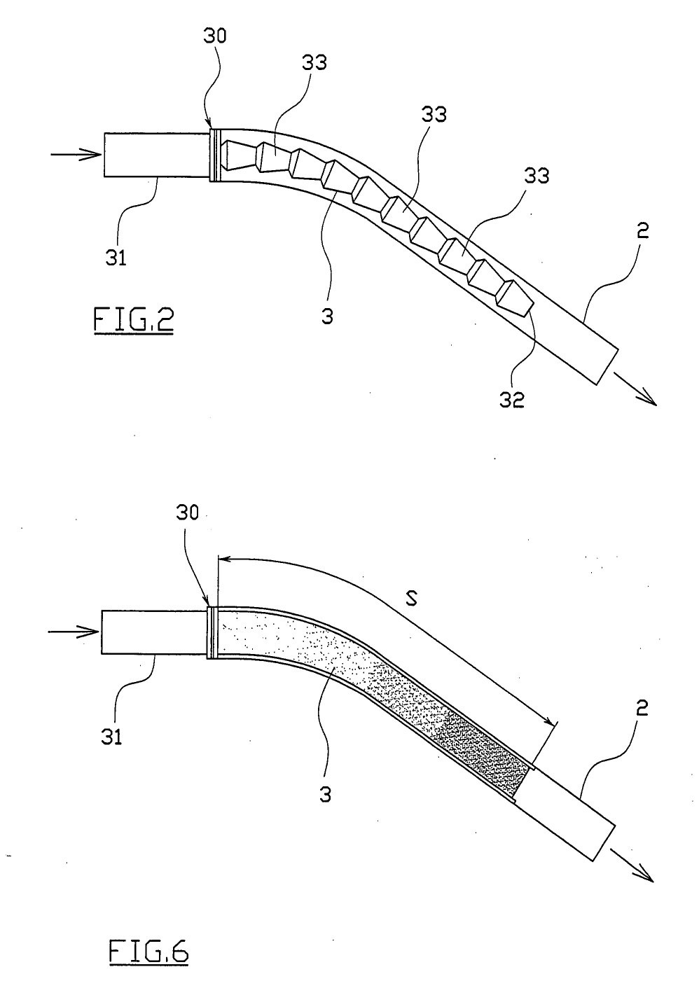

According to a preferred embodiment of the invention shown in FIG. 2, the first filtering baffle 3 consists of a thin sheet of porous material, preferably of cellulose, which is rolled up to assume the form of a tubular body. Said tubular body is inserted axially into the feed conduit 2, and is closed at its end by an impermeable base 32 positioned at the end distant from the connection piece 30, so that the transiting air is compelled to flow radially through its side wall of porous material.

To increase the filtering capacity of the filtering baffle 3, said side wall of porous material preferably presents a series of longitudinal folds which give it a characteristic star geometry.

To render the filtering baffle 3 sufficiently flexible for the purposes of the invention, said side wall of porous material presents a series of transverse folds instead, giving it a generally bellows configuration in the longitudinal direction.

In the illustrated embodiment, said bellows configuration comprises a succession of identical frusto-conical segments 33, which can be inclined to each other without damaging their constituent porous material.

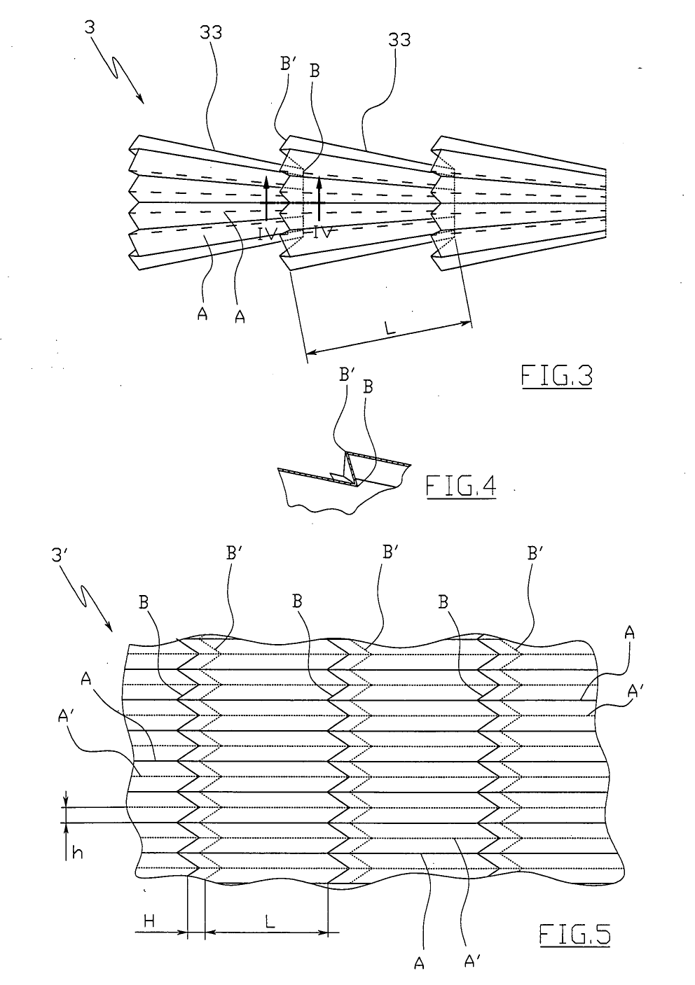

With reference to FIGS. 3, 4 and 5, a description is given hereinafter by way of non-limiting example of a method for folding a sheet of filter paper to obtain the aforedescribed filtering baffle 3. In FIG. 5, the continuous folding lines indicate that the nappes produced by the fold define an acute angle facing away from the observer, while the dashed folding lines indicate that the nappes produced by the fold define an acute angle facing the observer.

The method of the invention uses a sheet of filter paper 3′ of length equal to the overall length of the filtering baffle 3, and of width equal to the total circumferential development of its side wall.

The sheet 3′ is initially folded along two series of transverse folding lines B and B′ with opposite folding directions, they defining the bellows configuration of the filtering baffle 3.

The folding lines B lie at an equal distance L apart equal to the length of the frusto-conical portions to be formed.

The folding lines B′ also lie at an equal distance L apart, but are offset from the folding lines B by a distance H.

In particular, each nappe lying between a folding line B and that folding line B′ closest to it is folded onto the adjacent nappe such as to obtain local superposing of three flat portions of the sheet 3′.

The sheet 3′ folded in this manner is further folded along alternating longitudinal folding lines A and A′ with opposite folding directions, these being at equal distances h apart and intended to define the star geometry of the filtering baffle 3.

Preferably, said distance h is equal to two thirds of the distance H separating two adjacent transverse folding lines B and B′.

At this point, the sheet 3′ is rolled about an axis parallel to the longitudinal folding lines A and A′, and fixed along its edges to assume a tubular form. Finally, it is subjected to slight axial traction, enabling the individual frusto-conical segments 33 to be highlighted, as shown in FIG. 2.

In an alternative embodiment of the invention, shown in FIG. 6, the filtering baffle 3 can consist of a compact cylindrical body of porous material, which is inserted into the feed conduit such as to be traversed axially by the transiting air.

Preferably, said cylindrical body presents a porosity variable in the axial direction, in the sense of decreasing in the air flow direction.

In this manner, selective filtration can be achieved within the same filtering baffle 3, enabling the material to be more uniformly utilized, ensuring longer life and greater efficiency.

Preferably, a filtering baffle 3 of this type is constructed of polymer material, for example nylon, by a known as melt-blown production process.

This production process consists substantially of collecting on a movable surface microfibres of required dimensions, generated by a series of sized nozzles, to form a blanket of multi-layer material of variable porosity having the desired thickness S.

Said blanket of multi-layer material is then cut in the direction of its thickness, typically punched, to obtain cylinders of height S equal to the blanket thickness.

A cylinder obtained in this manner, having a diameter slightly less than the diameter of the feed conduit 2, forms the filtering baffle 3, which presents a high porosity in its air inlet section, and a low porosity in its outlet section; in this manner the coarse particles can be treated at the inlet, with gradual treatment of the smaller dimension particles towards the outlet.

The filtering baffle 3 obtained in this manner is evidently sufficiently flexible to follow the curves of the feed conduit 2.

1. A filtering system for the air directed towards an internal combustion engine intake, comprising a feed conduit (2) of generally constant cross-section conveying the air through two separate series-disposed filtering baffles (3, 4), of which a first filtering baffle (3) retains the large-dimension solid particles carried in suspension by said air, and a second filtering baffle (4) retains the smaller-dimension solid particles which have been allowed to pass by the first filtering baffle (3), characterised in that said first filtering baffle (3) is of generally elongated shape and is inserted directly into said air feed conduit (2).

2. A system as claimed in claim 1, characterised in that said first filtering baffle (3) is inserted into the air feed conduit (2) in a removable manner.

3. A system as claimed in claim 1, characterised in that said first filtering baffle (3) is flexible, such as to follow any sinuous development of the air feed conduit (2).

4. A system as claimed in claim 3, characterised in that said first filtering baffle (3) is a tubular body of porous material, which is inserted axially into the air feed conduit (2) and is closed at its end, such that the transiting air flows in a radial direction through its side wall.

5. A system as claimed in claim 4, characterised in that said side wall presents a series of longitudinal folds (A, A′) giving it a star geometry.

6. A system as claimed in claim 4, characterised in that said side wall presents a series of transverse folds (B, B′) giving it, in the longitudinal direction, a bellows form which provides it with a relative flexibility.

7. A system as claimed in claim 6, characterised in that said bellows form comprises a succession of frusto-conically shaped segments (33).

8. A system as claimed in claim 4, characterised in that said first filtering baffle (3) is made of cellulose.

9. A system as claimed in claim 3, characterised in that said first filtering baffle (3) is a generally cylindrical body of porous material, which is inserted into the feed conduit (2) such as to be traversed axially by the transiting air.

10. A system as claimed in claim 9, characterised in that said generally cylindrical body presents a porosity variable in the axial direction, in the sense of decreasing in the direction in which the transiting air flows.

11. A system as claimed in claim 9, characterised in that said first filtering baffle (3) is made of fibrous synthetic material.

12. A system as claimed in claim 1, characterised in that said first filtering baffle (3) presents an average pore size between 20 microns and 100 microns.

13. A system as claimed in claim 1, characterised in that said second filtering baffle (4) presents an average pore size less than 20 microns.
